(19) United States
(12) Patent Application Publication
(10) Pub. No.: US 2026/0057672 A1
(43) Pub. Date: Feb. 26, 2026

(54) RECOGNITION DEVICE, RECOGNITION SYSTEM, AND COMPUTER PROGRAM

(71) Applicant: Konica Minolta, Inc., Tokyo (JP)

(72) Inventors: RYO HACHIUMA, Osaka-shi, Osaka (JP); TAIKI SEKII, Takatsuki-shi, Osaka (JP)

(21) Appl. No.: 18/873,540

(22) PCT Filed: May 30, 2023
(86) PCT No.: PCT/JP2023/020052

§ 371 Date: Nov. 10, 2025

(30) Foreign Application Priority Data
Jun. 13, 2022 (JP) 2022-095096

(51) Int. Cl. G06V 20/40; G06V 10/44; G06V 10/62; G06V 10/77; G06V 10/82; G06V 40/10; G06V 40/20

(52) U.S. Cl. CPC G06V 20/44; G06V 10/44; G06V 10/62; G06V 10/77; G06V 10/82; G06V 40/10; G06V 40/20

(57) ABSTRACT

To provide a recognition device that suppresses a decrease in recognition accuracy. A recognition device that performs recognition processing on a video obtained by capturing includes a neural network 172 that extracts, from a video including a plurality of pixels having a size of a first unit and a plurality of objects having a size of a second unit larger than the size of the first unit and smaller than a size of an entire video, an individual feature quantity indicating a feature of the pixel having the size of the first unit, a MaxPooling unit 173 that aggregates, in a case where a plurality of individual feature quantities are extracted, the plurality of extracted individual feature quantities for each object having the size of the second unit, and a DNN unit 178 that recognizes an event appearing in the video on the basis of an aggregation result.

### TECHNICAL FIELD

The present disclosure relates to a technique of recognizing an action of a person or the like from a moving image generated by capturing with a camera, and particularly to a technique of aggregating feature quantities obtained from the moving image in a recognition process.

### BACKGROUND ART

The technique of recognizing an action of a person or the like from a moving image generated by capturing with a camera is required in various fields such as video analysis of a monitoring camera and analysis of a sport video.

According to Non Patent Literature 1, a skeleton of a person, that is, a set of joint points of a person is detected from an input moving image, and deep neural network (DNN) processing is performed on each detected joint point to extract a feature vector. Next, all the extracted feature vectors are aggregated by the GlobalMaxPooling module. Here, in GlobalMaxPooling, aggregation is performed by MaxPooling using a window size including all the feature vectors. The input moving image is recognized using the feature vectors aggregated in this manner.

### CITATION LIST

### Non Patent Literature

Non Patent Literature 1: Yukun Su, Guosheng Lin, Jinhui Zhu, Qingyao Wu, “Human Interaction Learning on 3D Skeleton Point Clouds for Video Violence Recognition”, European Conference on Computer Vision 2020, UK, 29 Oct. 2020, p. 74-90
Non Patent Literature 2: Zhe Cao, Gines Hidalgo, Tomas Simon, Shih-En Wei, Yaser Sheikh, “OpenPose: Realtime Multi-Person 2D Pose Estimation using Part Affinity Fields”, Internet <https://arxiv.org/abs/1812.08008>
Non Patent Literature 3: Joseph Redmon, Santosh Divvala, Ross Girshick, Ali Farhadi, “You Only Look Once: Unified, Real-Time Object Detection”, Computer Vision and Pattern Recognition (CVPR) 2016
Non Patent Literature 4: Nicolai Wojke, Alex Bewley, Dietrich Paulus, “SIMPLE ONLINE AND REALTIME TRACKING WITH A DEEP ASSOCIATION METRIC”, 21 Mar. 2017, Internet <https://arxiv.org/pdf/1703.07402.pdf>

### SUMMARY OF INVENTION

### Technical Problem

According to Non Patent Literature 1, since all the feature vectors extracted from all the joint points are aggregated for the entire moving image without distinction of frames and objects, there is a possibility that a plurality of originally unrelated joint points are associated with each other depending on a situation in which the moving image is generated by capturing. For this reason, there is a possibility that the recognition result derived using the feature vectors obtained by aggregation is erroneous, and there is a possibility that the accuracy of recognition by a recognition device decreases.

An object of the present disclosure is to provide a recognition device, a recognition system, and a computer program capable of suppressing such decrease in recognition accuracy.

### Solution to Problem

In order to achieve the object, one aspect of the present disclosure is a recognition device that performs recognition processing on a video obtained by capturing, the recognition device including an extraction unit that extracts, from a video including a plurality of unit images having a size of a first unit and a plurality of unit images having a size of a second unit larger than the size of the first unit and smaller than a size of an entire video, an individual feature quantity indicating a feature of the unit image having the size of the first unit, an aggregation unit that aggregates, in a case where a plurality of individual feature quantities are extracted by the extraction unit, the plurality of extracted individual feature quantities for each unit image having the size of the second unit, and a recognition unit that recognizes an event appearing in the video based on an aggregation result.

The aggregation unit may aggregate a plurality of extracted individual feature quantities to generate an aggregated feature quantity, and the recognition unit may recognize an event by using the aggregated feature quantity generated.

The video may further include a plurality of unit images having a size of a third unit larger than a size of a second unit and smaller than a size of an entire video, the aggregation unit may aggregate a plurality of extracted individual feature quantities to generate a first aggregated feature quantity, the extraction unit may further extract a second individual feature quantity indicating a feature of a unit image having the size of the second unit from the first aggregated feature quantity, in a case where a plurality of second individual feature quantities are extracted by the extraction unit, the aggregation unit may further aggregate the plurality of extracted second individual feature quantities for each unit image having the size of the third unit to generate a second aggregated feature quantity, and the recognition unit may recognize an event by using the second aggregated feature quantity generated.

The video may be a moving image including a plurality of frame images, each frame image may include a plurality of point images arranged in a matrix, and each frame image may include a plurality of objects, the first unit may correspond to a point image, the second unit may correspond to an object, and the third unit may correspond to a frame image.

The extraction unit may calculate the second individual feature quantity from the first aggregated feature quantity generated using a neural network having a permutation-equivariant characteristic in which a same output can be obtained even if an order of inputs changes.

The video may include an object, the recognition device may further include a point detection unit that detects, from the video, point information indicating a skeletal point on a skeleton or a vertex on a contour of an object included in the video, and the extraction unit may extract an individual feature quantity from the point information detected.

The video may be a moving image including a plurality of frame images, each frame image may include a plurality of point images arranged in a matrix, and each frame image may include a plurality of objects, and the unit image having a size of the second unit may correspond to a plurality of frame images, a frame image, or an object in the moving image.

The point information may include position coordinates indicating a position where a skeletal point or a vertex indicated by the point information is present in a frame image, and time axis coordinates indicating a frame image in which the skeletal point or the vertex indicated by the point information is present among a plurality of frame images.

The point information may include a feature vector indicating a unique identifier of the object, the point information may further include at least one of a detection score indicating likelihood of a skeletal point or a vertex indicated by the point information detected, a feature vector indicating a type of an object including the skeletal point or the vertex indicated by the point information, a feature vector indicating a type of the point information, or a feature vector indicating an appearance of the object.

The point detection unit may detect point information from one frame image or a plurality of frame images among the plurality of frame images.

The point detection unit may detect the point information by neural network computation detection processing.

The extraction unit may calculate the individual feature quantity from the point information using a neural network having a permutation-equivariant characteristic in which a same output can be obtained even if an order of inputs changes.

The neural network having a permutation-equivariant characteristic may be a neural network that performs neuro computation detection processing for each individual feature quantity.

A number of aggregated feature quantities generated by the aggregation unit may be smaller than a number of individual feature quantities generated by the extraction unit.

The video may further include a plurality of unit images having a size of a third unit larger than a size of a second unit, the aggregation unit may aggregate a plurality of extracted individual feature quantities to generate a first aggregated feature quantity, in a case where a plurality of individual feature quantities are extracted by the extraction unit, the aggregation unit may further aggregate a plurality of individual feature quantities for each unit image having the size of the third unit to generate a second individual feature quantity, and combine the second aggregated feature quantity generated with the first aggregated feature quantity generated for each second unit to generate a combined aggregated feature quantity, and the recognition unit may recognize an event by using the combined aggregated feature quantity generated.

The aggregation unit may aggregate a plurality of extracted individual feature quantities to generate a first aggregated feature quantity, in a case where a plurality of individual feature quantities are extracted by the extraction unit, the aggregation unit may further aggregate a plurality of individual feature quantities in the entire video to generate a second individual feature quantity, and combine the second aggregated feature quantity generated with the first aggregated feature quantity generated for each second unit to generate a combined aggregated feature quantity, and the recognition unit may recognize an event by using the combined aggregated feature quantity generated.

The recognition unit may perform individual action recognition processing of recognizing an action for each recognition target in the video by neuro computation processing using an aggregation result by the aggregation unit.

A degree-of-contribution calculation unit may further be included, and the degree-of-contribution calculation unit calculates a degree of contribution of the recognition target to a recognition result by backpropagating gradient information related to a neuro computation using the recognition result obtained by recognition.

In addition, one aspect of the present disclosure is a recognition system including a capturing device that generates a video by capturing, and the recognition device described above.

Furthermore, one aspect of the present disclosure is a computer program for control used in a recognition device that performs recognition processing on a video obtained by capturing, the program may cause the recognition device, which is a computer, to perform an extraction step of extracting, from a video including a plurality of unit images having a size of a first unit and a plurality of unit images having a size of a second unit larger than the size of the first unit and smaller than a size of an entire video, an individual feature quantity indicating a feature of the unit image having the size of the first unit, an aggregation step of aggregating, in a case where a plurality of individual feature quantities are extracted by the extraction step, the plurality of extracted individual feature quantities for each unit image having the size of the second unit, and a recognition step of recognizing an event appearing in the video based on an aggregation result by the aggregation step.

### Advantageous Effects of Invention

According to this aspect, since the plurality of extracted individual feature quantities are aggregated for each unit image having the size of the second unit, the possibility that the aggregated feature quantity of the unit image having the size of the second unit is damaged by another unit image having the same size of the second unit can be suppressed to be low. As a result, it is possible to obtain an excellent effect that a decrease in the accuracy of recognition performed on the basis of the aggregated feature quantity can be suppressed.

### BRIEF DESCRIPTION OF DRAWINGS

FIG. 1 illustrates a configuration of a monitoring system 1 of a first example.

FIG. 2 is a block diagram illustrating a configuration of a recognition device 10 of the first example.

FIG. 3 is a block diagram illustrating a configuration of a typical neural network 50.

FIG. 4 is a schematic diagram illustrating one neuron U of the neural network 50.

FIG. 5 is a diagram schematically illustrating a data propagation model during pre-training (training) in the neural network 50.

FIG. 6 is a diagram schematically illustrating a data propagation model at the time of practical inference in the neural network 50.

FIG. 7 is a block diagram illustrating a configuration of a recognition processing unit 121.

FIG. 8 is a flowchart (part 1) illustrating an operation in the recognition device 10, which continues to FIG. 9.

FIG. 9 is a flowchart (part 2) illustrating the operation in the recognition device 10.

FIG. 10 is a block diagram illustrating a configuration of a recognition processing unit 121a of a second example.

FIG. 11 is a flowchart (part 1) illustrating an operation in a recognition device 10 of the second example, which continues to FIG. 12.

FIG. 12 is a flowchart (part 2) illustrating the operation in the recognition device 10 of the second example.

FIG. 13 is a block diagram illustrating a configuration of a recognition processing unit 121b of a third example.

FIG. 14 is a flowchart (part 1) illustrating an operation in a recognition device 10 of the third example.

FIG. 15 is a block diagram illustrating a configuration of a recognition processing unit 121c of a fourth example.

FIG. 16 is a flowchart illustrating an operation in a recognition device 10 of the fourth example.

### DESCRIPTION OF EMBODIMENTS

### 1. First Example

### 1.1 Monitoring System 1

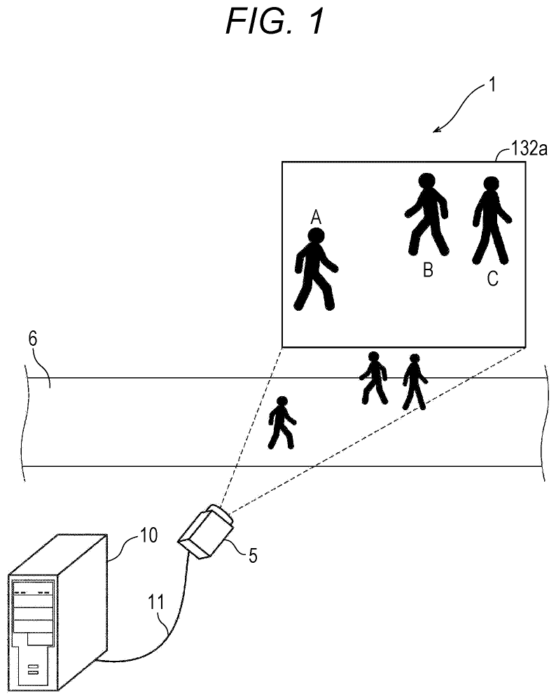

A monitoring system 1 (recognition system) of a first example will be described with reference to FIG. 1.

The monitoring system 1 constitutes a part of a security management system, and includes a camera 5 (capturing device) and a recognition device 10.

The camera 5 is fixed at a predetermined position and installed to face in a predetermined direction. The camera 5 is connected to the recognition device 10 via a cable 11.

As an example, the camera 5 captures a person or the like passing through a passage 6 and generates a frame image. The camera 5 continuously captures a person or the like passing through the passage 6, and thus generates a plurality of frame images. In this manner, the camera 5 generates a moving image including the plurality of frame images. The camera 5 transmits the moving image to the recognition device 10 as needed. The recognition device 10 receives the moving image from the camera 5.

The recognition device 10 analyzes the moving image received from the camera 5 and recognizes an action pattern of a person or the like captured in the moving image. For example, in a case where a person or the like captured in the moving image is playing sports (baseball, basketball, soccer, and the like), the recognition device 10 analyzes the received moving image and recognizes that the person or the like captured in the moving image is playing sports as an action pattern.

In FIG. 1, a frame image 132a indicates a frame image generated by the camera 5. This does not indicate that the frame image 132a is projected on the wall surface of the passage 6.

As described above, the moving image (video) includes a plurality of frame images, and each frame image includes a plurality of pixels (point images) arranged in a matrix. Each frame image includes an object such as a person or an object.

Here, each of the pixel, the object, the frame image, the plurality of frame images, and the video can correspond to the size of one of different units.

For example, the pixel can correspond to a unit image having a size of a first unit, and the object can correspond to a unit image having a size of a second unit larger than the size of the first unit. In addition, the object can correspond to a unit image having the size of the first unit, and the frame image can correspond to a unit image having the size of the second unit larger than the size of the first unit. Moreover, the frame image can correspond to a unit image having the size of the first unit, and a part of the video, that is, a plurality of frame images in the video can correspond to a unit image having the size of the second unit larger than the size of the first unit.

Furthermore, for example, the pixel can correspond to a unit image having the size of the first unit, the object can correspond to a unit image having the size of the second unit larger than the size of the first unit, and the frame image may correspond to a unit image having a size of a third unit larger than the size of the second unit.

### 1.2 Recognition Device 10

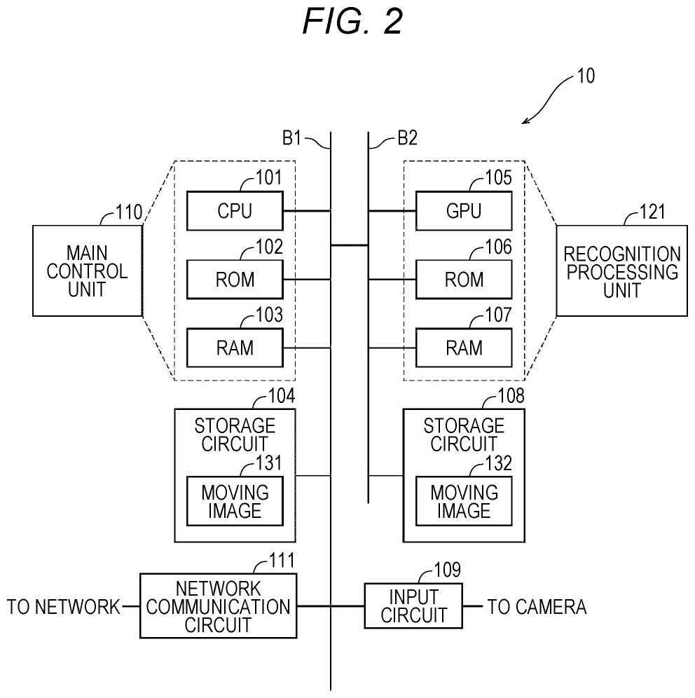

As illustrated in FIG. 2, the recognition device 10 includes a central processing unit (CPU) 101, a read only memory (ROM) 102, a random access memory (RAM) 103, a storage circuit 104, an input circuit 109, and a network communication circuit 111, which are connected to a bus B1, and a graphics processing unit (GPU) 105, a ROM 106, a RAM 107, and a storage circuit 108, which are connected to a bus B2. The bus B1 and the bus B2 are connected to each other.

### (CPU 101, ROM 102, and RAM 103)

The RAM 103 includes a semiconductor memory, and provides a work area when the CPU 101 executes a program.

The ROM 102 includes a semiconductor memory. The ROM 102 stores a control program that is a computer program for executing processing in the recognition device 10, and the like.

The CPU 101 is a processor that operates in accordance with a control program stored in the ROM 102.

By the CPU 101 operating in accordance with the control program stored in the ROM 102 using the RAM 103 as a work area, the CPU 101, the ROM 102, and the RAM 103 constitute a main control unit 110.

### (Network Communication Circuit 111)

The network communication circuit 111 is connected to an external information terminal via a network. The network communication circuit 111 relays transmission and reception of information to and from the external information terminal via the network. For example, the network communication circuit 111 transmits a recognition result by a recognition processing unit 121 to be described later to the external information terminal via the network.

### (Input Circuit 109)

The input circuit 109 is connected to the camera 5 via the cable 11.

The input circuit 109 receives a moving image from the camera 5 and writes the received moving image into the storage circuit 104.

### (Storage Circuit 104)

The storage circuit 104 includes, for example, a hard disk drive.

The storage circuit 104 stores, for example, a moving image 131 received from the camera 5 via the input circuit 109.

### (Main Control Unit 110)

The main control unit 110 integrally controls the entire recognition device 10.

Furthermore, the main control unit 110 executes control to write the moving image 131 stored in the storage circuit 104 into the storage circuit 108 as a moving image 132 via the bus B1 and the bus B2. Moreover, the main control unit 110 outputs an instruction to start recognition processing to the recognition processing unit 121 via the bus B1 and the bus B2.

The main control unit 110 receives a label of a recognition result from the recognition processing unit 121 via the bus B2 and the bus B1. When receiving the label, the main control unit executes control to transmit the received label to the external information terminal via the network communication circuit 111 and the network.

### (GPU 105, ROM 106, and RAM 107)

The RAM 107 includes a semiconductor memory, and provides a work area when the GPU 105 executes a program.

The ROM 106 includes a semiconductor memory. The ROM 106 stores a control program that is a computer program for executing processing in the recognition processing unit 121, and the like.

The GPU 105 is a graphic processor that operates in accordance with a control program stored in the ROM 106.

By the GPU 105 operating in accordance with the control program stored in the ROM 106 using the RAM 107 as a work area, the GPU 105, the ROM 106, and the RAM 107 constitute the recognition processing unit 121.

A neural network or the like is incorporated in the recognition processing unit 121. The neural network or the like incorporated in the recognition processing unit 121 performs its function by the GPU 105 operating in accordance with the control program stored in the ROM 106.

Details of the recognition processing unit 121 will be described later.

### (Storage Circuit 108)

The storage circuit 108 includes a semiconductor memory. The storage circuit 108 is, for example, a solid state drive (SSD).

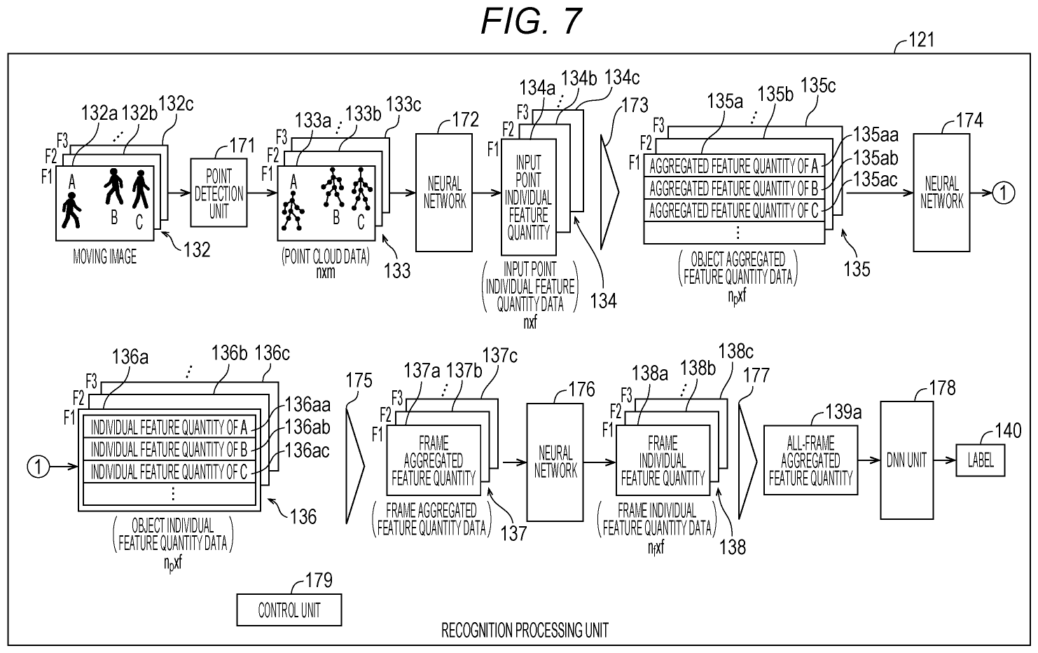

The storage circuit 108 stores, for example, the moving image 132 including frame images 132a, 132b, 132c, . . . (see FIG. 7).

### 1.3 Typical Neural Network

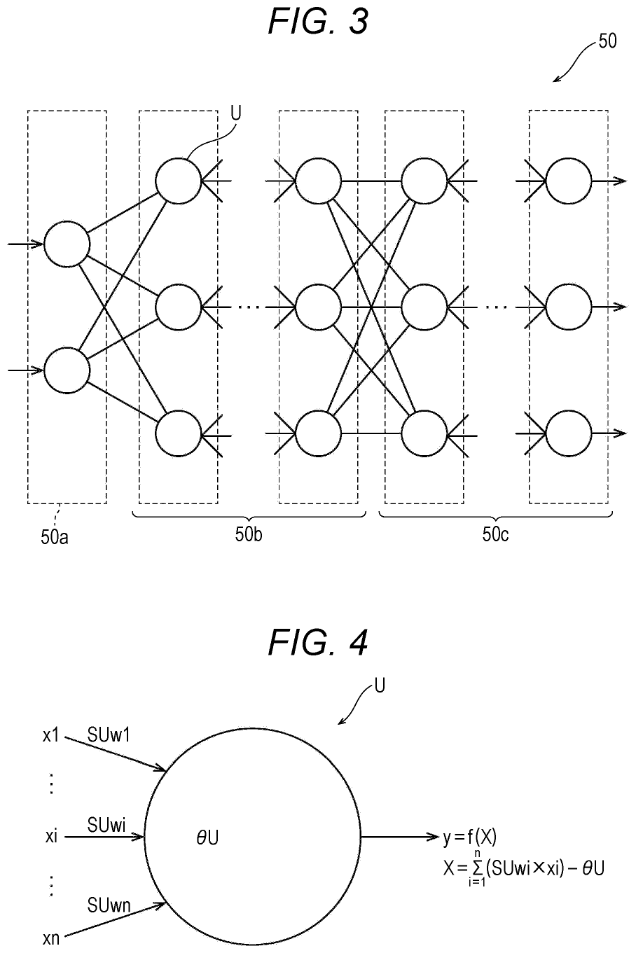

As an example of a typical neural network, a neural network 50 illustrated in FIG. 3 will be described.

### (1) Structure of Neural Network 50

As illustrated in the drawing, the neural network 50 is a hierarchical neural network including an input layer 50a, a feature extraction layer 50b, and a recognition layer 50c.

Here, the neural network is an information processing system that mimics a human neural network. In the neural network 50, an engineering neuron model corresponding to a nerve cell is referred to as a neuron U herein. The input layer 50a, the feature extraction layer 50b, and the recognition layer 50c each include a plurality of neurons U.

The input layer 50a usually includes one layer. Each neuron U in the input layer 50a receives, for example, a pixel value of each pixel constituting one image. The received image value is directly output from each neuron U in the input layer 50a to the feature extraction layer 50b.

The feature extraction layer 50b extracts features from data (all the pixel values constituting one image) received from the input layer 50a, and outputs the features to the recognition layer 50c. The feature extraction layer 50b extracts, for example, a region in which a person appears from the received image by computation in each neuron U.

The recognition layer 50c performs identification using the features extracted by the feature extraction layer 50b. The recognition layer 50c identifies the direction of the person, the gender of the person, the clothes of the person, and the like from the region of the person extracted in the feature extraction layer 50b by computation in each neuron U, for example.

As the neuron U, a multiple-input single-output element is usually used as illustrated in FIG. 4. A signal is transmitted only in one direction, and the input signal xi (i=1, 2, . . . , n) is multiplied by a certain neuron weight (SUwi) and input to the neuron U. This neuron weight represents the strength of connection between the neuron U and the neuron U arranged in a hierarchical manner. The neuron weight can be varied by learning. From the neuron U, a value X obtained by subtracting a neuron threshold θU from the sum of the input values (SUwi×xi) each of which is multiplied by the neuron weight SUwi is output after being transformed by a response function f(X). That is, an output value y of the neuron U is expressed by the following mathematical formula.

$$y = f ( X )$$

where
X=Σ(SUwi×xi)−θU As the response function, for example, a sigmoid function can be used.

Each neuron U in the input layer 50a usually does not have a sigmoid characteristic or a neuron threshold. Therefore, the input value directly appears in the output. On the other hand, each neuron U in the final layer (output layer) of the recognition layer 50c outputs the identification result in the recognition layer 50c.

As a learning algorithm of the neural network 50, for example, a back propagation method (back propagation) is used in which a neuron weight and the like of the recognition layer 50c and a neuron weight and the like of the feature extraction layer 50b are sequentially changed using the steepest descent method in a manner that the square error between a value (data) indicating a correct answer and an output value (data) from the recognition layer 50c is minimized.

### (2) Training Step

A training step in the neural network 50 will be described.

The training step is a step of performing pre-training of the neural network 50. In the training step, pre-training of the neural network 50 is performed using image data with a correct answer (supervised, annotated) obtained in advance.

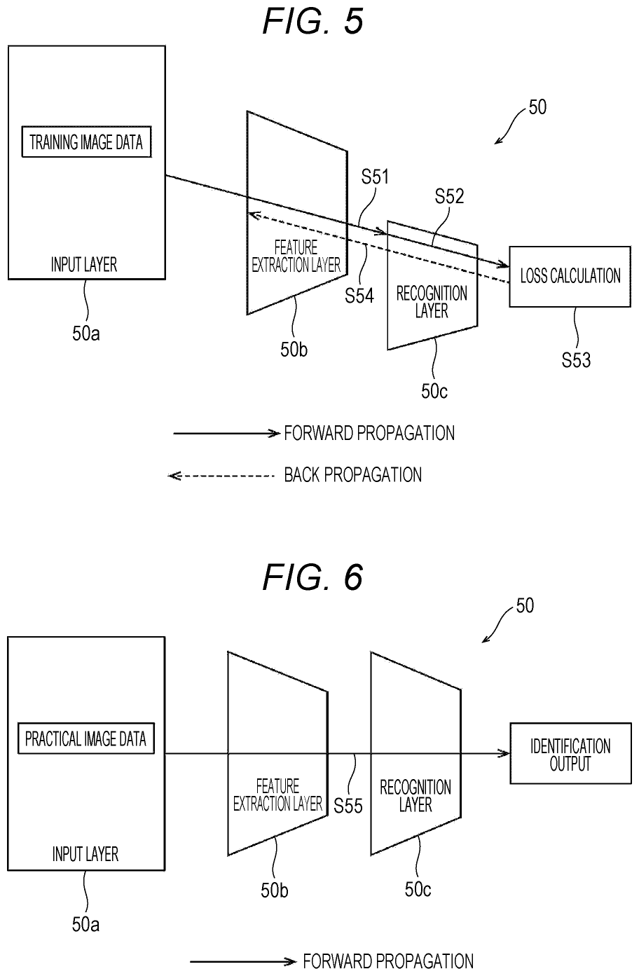

FIG. 5 schematically illustrates a data propagation model at the time of pre-training.

Each image in image data is input to the input layer 50a of the neural network 50, and is output from the input layer 50a to the feature extraction layer 50b. In each neuron U in the feature extraction layer 50b, a computation with a neuron weight is performed on the input data. With this computation, in the feature extraction layer 50b, a feature (for example, a region of a person) is extracted from the input data, and data indicating the extracted feature is output to the recognition layer 50c (step S51).

In each neuron U in the recognition layer 50c, the computation with the neuron weight is performed on the input data (step S52). As a result, identification (for example, identification of a person) based on the features is performed. Data indicating the identification result is output from the recognition layer 50c.

The output value (data) of the recognition layer 50c is compared with a value indicating a correct answer, and the error (loss) between them is calculated (step S53). The neuron weight and the like of the recognition layer 50c and the neuron weight and the like of the feature extraction layer 50b are sequentially changed so as to reduce the error (back propagation) (step S54). As a result, the recognition layer 50c and the feature extraction layer 50b are learned.

### (3) Practical Recognition Step

A practical recognition step in the neural network 50 will be described.

FIG. 6 illustrates a data propagation model in a case where recognition (for example, recognition of the gender of a person) is actually performed by using data obtained on site as an input using the neural network 50 learned by the training step.

In the practical recognition step in the neural network 50, feature extraction and recognition are performed using the learned feature extraction layer 50b and the learned recognition layer 50c (step S55).

### 1.4 Recognition Processing Unit 121

As illustrated in FIG. 7, the recognition processing unit 121 includes a point detection unit 171, a neural network 172, a MaxPooling unit 173, a neural network 174, a MaxPooling unit 175, a neural network 176, a MaxPooling unit 177, a DNN unit 178, and a control unit 179.

The recognition processing unit 121 receives an instruction to start recognition processing from the main control unit 110. When receiving the instruction to start the recognition processing, the recognition processing unit 121 starts the recognition processing.

### (1) Point Detection Unit 171

When receiving the instruction to start the recognition processing from the main control unit 110, the point detection unit 171 (point detection unit) reads the moving image 132 including the frame images 132a, 132b, 132c, . . . from the storage circuit 108. Here, each of the unit of the frame image 132a, the unit of the frame image 132b, the unit of the frame image 132c, . . . is referred to as a frame, and as illustrated in FIG. 7, the frames are indicated as F1, F2, and F3, respectively.

Here, as illustrated in FIG. 7, as an example, the frame image 132a includes objects representing a person A, a person B, and a person C, respectively. Images of persons, images of objects, and the like included in the frame images 132a, 132b, 132c, . . . are referred to as objects.

The point detection unit 171 detects and recognizes objects such as a person and an object from the frame images 132a, 132b, 132c, . . . constituting the moving image 132.

In addition, the point detection unit 171 detects point information indicating skeletal points (joint points) on the skeleton of an object such as a person using OpenPose (see Non Patent Literature 2) from the frame images 132a, 132b, 132c, . . . constituting the moving image 132. Here, the skeletal point is represented by a coordinate value (X coordinate value, Y coordinate value) of a position where the skeletal point is present in the frame image and a coordinate value (time t or frame number t indicating frame image) on the time axis corresponding to the frame image in which the skeletal point is present.

The point detection unit 171 may detect point information indicating an end point (vertex) on the contour of an object such as a person or an object using YOLO (see Non Patent Literature 3) from the frame images 132a, 132b, 132c, . . . constituting the moving image 132. Here, the end point is also represented by a coordinate value (X coordinate value, Y coordinate value) of a position where the end point is present in the frame image and a coordinate value (time t or frame number t indicating frame image) on the time axis corresponding to the frame image in which the end point is present.

Furthermore, the point information may further include a feature vector indicating a unique identifier of the object.

Moreover, the point information may further include at least one of (a) a detection score indicating likelihood of a skeletal point or a vertex indicated by the detected point information, (b) a feature vector indicating the type of an object including the skeletal point or the vertex indicated by the point information, (c) a feature vector indicating the type of the point information, or (d) a feature vector indicating the appearance of the object.

The point detection unit 171 generates point cloud data 133 including a plurality of pieces of detected point information (indicating a plurality of skeletal points or a plurality of end points) from the moving image 132 including the frame images 132a, 132b, 132c, . . . .

For easy understanding of association between the moving image 132 and the point cloud data 133, in FIG. 7, the point cloud data 133 is represented so as to include frame point clouds 133a, 133b, 133c, . . . , respectively corresponding to the frame images 132a, 132b, 132c, . . . included in the moving image 132.

However, as described above, since the point information includes the coordinate value (X coordinate value, Y coordinate value) of the position where the joint point or the end point is present in the frame image and the coordinate value (time t) on the time axis corresponding to the frame image in which the joint point or the end point is present, point clouds such as the frame point clouds 133a, 133b, 133c, . . . illustrated in FIG. 7 are not necessarily present, and thus attention is required. Hereinafter, the same representation method is adopted.

The point detection unit 171 writes the point cloud data 133 into the storage circuit 108.

As illustrated in FIG. 7, the point cloud data 133 includes features of m dimensions for each of skeletal points (or end points) indicated by n pieces of point information. That is, n is the total number of skeleton points (or end points) indicated by the point information included in the point cloud data 133, and m is the number of dimensions of the feature of each skeletal point (or each end point).

Furthermore, as illustrated in FIG. 7, as an example, the frame point cloud 133a includes a person point cloud A, a person point cloud B, and a person point cloud C detected from the person A, the person B, and the person C, respectively.

Here, since the frame point clouds 133a, 133b, 133c, . . . are generated from the frame images 132a, 132b, 132c, . . . , respectively, each of the unit of the frame point cloud 133a, the unit of the frame point cloud 133b, the unit of the frame point cloud 133c, . . . is referred to as a frame. Furthermore, in the following description, the unit of a feature quantity generated corresponding to each of the frame point clouds 133a, 133b, 133c, . . . is also referred to as a frame.

The point detection unit 171 may detect the point information from one frame image among the plurality of frame images constituting the moving image or some of the plurality of frame images constituting the moving image.

In addition, the point detection unit 171 may detect the point information by neural network computation detection processing.

Moreover, the point detection unit 171 may use one or more of convolutional neural networks and self-attention mechanisms.

### (2) Neural Network 172

The neural network 172 (extraction unit) reads the point cloud data 133 from the storage circuit 108.

The neural network 172 detects an individual feature quantity indicating the feature of the point information from the detected point information for each piece of the point information.

That is, the neural network 172 performs neural network processing on the read point cloud data 133 to generate input point individual feature quantity data 134 including the individual feature quantity of each input point (skeletal point or end point indicated by the point information).

As described above, for easy understanding, the input point individual feature quantity data 134 is represented so as to include input point individual feature quantities 134a, 134b, 134c, . . . corresponding to the frames (FIG. 7).

The neural network 172 writes the generated input point individual feature quantity data 134 into the storage circuit 108.

As illustrated in FIG. 7, the input point individual feature quantity data 134 includes features of f dimensions for each of n input points (skeletal points or end points). That is, n is the total number of input points included in the input point individual feature quantity data 134, and f is the number of dimensions of the feature of each input point.

As described above, each of the unit of the input point individual feature quantity 134a, the unit of the input point individual feature quantity 134b, the unit of the input point individual feature quantity 134c, . . . is referred to as a frame.

The neural network 172 may calculate the individual feature quantity from the point information using a neural network having a permutation-equivariant characteristic (forward identity) in which the same output can be obtained even if the order of inputs changes.

The neural network having the permutation-equivariant characteristic may be a neural network that performs neuro computation detection processing for each individual feature quantity.

### (3) MaxPooling Unit 173

The MaxPooling unit 173 (aggregation unit) reads the input point individual feature quantity data 134 from the storage circuit 108.

For the read input point individual feature quantity data 134, the MaxPooling unit 173 aggregates the input point individual feature quantities for each object using GlobalMaxPooling, and generates object aggregated feature quantity data 135.

Here, in GlobalMaxPooling, MaxPooling using a window size including all the input point individual feature quantities corresponding to the object is performed for each object.

As described above, since the MaxPooling unit 173 aggregates the input point individual feature quantity data 134 for each object, the window size corresponds to the total number of input point individual feature quantities corresponding to each object.

By performing GlobalMaxPooling, it is possible to satisfy forward invariance that the output is invariant even in a case where permutations of points are switched and the points are input to the neural network.

As described above, for easy understanding, the object aggregated feature quantity data 135 is represented so as to include object aggregated feature quantities 135a, 135b, 135c, . . . corresponding to the frames.

Each of the object aggregated feature quantities 135a, 135b, 135c, . . . acquires the forward invariance for each object.

Here, as an example, as illustrated in FIG. 7, the object aggregated feature quantity 135a includes an aggregated feature quantity 135aa corresponding to the object of the person A, an aggregated feature quantity 135ab corresponding to the object of the person B, an aggregated feature quantity 135ac corresponding to the object of the person C . . . . The aggregated feature quantity 135aa, the aggregated feature quantity 135ab, the aggregated feature quantity 135ac . . . each include a plurality of aggregated feature quantities.

Each of the unit of the object aggregated feature quantity 135a, the unit of the object aggregated feature quantity 135b, the unit of the object aggregated feature quantity 135c, . . . is referred to as a frame.

The MaxPooling unit 173 writes the generated object aggregated feature quantity data 135 into the storage circuit 108.

Here, as illustrated in FIG. 7, the object aggregated feature quantity data 135 includes features of f dimensions for each of np objects (persons or objects). That is, np is the total number of objects included in the object aggregated feature quantity data 135, and f is the number of dimensions of the feature of each object.

The number of aggregated feature quantities generated by the MaxPooling unit 173 is less than the number of individual feature quantities generated by the neural network 172.

The MaxPooling unit 173 may use any of AveragePooling, SoftmaxPooling, and SelfAttention instead of MaxPooling.

### (4) Neural Network 174

The neural network 174 (extraction unit) reads the object aggregated feature quantity data 135 from the storage circuit 108.

The neural network 174 performs the neural network processing on the read object aggregated feature quantity data 135, detects the individual feature quantity indicating the feature of the object for each object, and generates object individual feature quantity data 136 including the individual feature quantity of each object.

As described above, for easy understanding, the object individual feature quantity data 136 is represented so as to include object individual feature quantities 136a, 136b, 136c, . . . corresponding to the frames.

Here, as an example, as illustrated in FIG. 7, the object individual feature quantity 136a includes an individual feature quantity 136aa of the object of the person A, an individual feature quantity 136ab of the object of the person B, an individual feature quantity 136ac of the object of the person C . . . . The individual feature quantity 136aa, the individual feature quantity 136ab, the individual feature quantity 136ac, . . . each include a phurality of individual feature quantities.

The neural network 174 writes the generated object individual feature quantity data 136 into the storage circuit 108.

Here, as illustrated in FIG. 7, the object individual feature quantity data 136 includes features of f dimensions for each of np objects (persons or objects). That is, np is the total number of objects included in the object individual feature quantity data 136, and f is the number of dimensions of the feature of each object.

Each of the unit of the object individual feature quantity 136a, the unit of the object individual feature quantity 136b, the unit of the object individual feature quantity 136c, . . . is referred to as a frame.

The neural network 174 calculates the individual feature quantity from the generated aggregated feature quantity using a neural network having a permutation-equivariant characteristic in which the same output can be obtained even if the order of inputs changes.

The neural network having the permutation-equivariant characteristic may be a neural network that performs neuro computation detection processing for each individual feature quantity.

### (5) MaxPooling Unit 175

The MaxPooling unit 175 (aggregation unit) reads the object individual feature quantity data 136 from the storage circuit 108.

For the read object individual feature quantity data 136, the MaxPooling unit 175 aggregates the object individual feature quantities for each frame using GlobalMaxPooling, and generates frame aggregated feature quantity data 137.

Here, in GlobalMaxPooling, MaxPooling using a window size including all the object individual feature quantities corresponding to the frame is performed for each frame.

As described above, since the MaxPooling unit 175 aggregates the object individual feature quantity data 136 for each frame, the window size corresponds to the total number of object individual feature quantities corresponding to each frame.

As described above, for easy understanding, the frame aggregated feature quantity data 137 is represented so as to include frame aggregated feature quantities 137a, 137b, 137c, . . . corresponding to the frames.

Each of the frame aggregated feature quantities 137a, 137b, 137c, . . . acquires the forward invariance for each frame.

Each of the unit of the frame aggregated feature quantity 137a, the unit of the frame aggregated feature quantity 137b, the unit of the frame aggregated feature quantity 137c, . . . is referred to as a frame.

The MaxPooling unit 175 writes the generated frame aggregated feature quantity data 137 into the storage circuit 108.

The number of aggregated feature quantities generated by the MaxPooling unit 175 is less than the number of individual feature quantities generated by the neural network 174.

The MaxPooling unit 175 may use any of AveragePooling, SoftmaxPooling, and SelfAttention instead of MaxPooling.

### (6) Neural Network 176

The neural network 176 (extraction unit) reads the frame aggregated feature quantity data 137 from the storage circuit 108.

The neural network 176 performs the neural network processing on the read frame aggregated feature quantity data 137, detects the individual feature quantity indicating the feature of the frame for each frame, and generates frame individual feature quantity data 138 including the individual feature quantity of each frame.

As described above, for easy understanding, the frame individual feature quantity data 138 is represented so as to include frame individual feature quantities 138a, 138b, 138c, . . . corresponding to the frames.

Here, as an example, as illustrated in FIG. 7, the frame individual feature quantity 138a includes an individual feature quantity corresponding to the frame F1, the frame individual feature quantity 138b includes an individual feature quantity corresponding to the frame F2, and the frame individual feature quantity 138c includes an individual feature quantity corresponding to the frame F3.

The neural network 176 writes the generated frame individual feature quantity data 138 into the storage circuit 108.

Here, as illustrated in FIG. 7, the frame individual feature quantity data 138 includes features of f dimensions for each of nf frames. That is, nf is the total number of frames included in the frame individual feature quantity data 138, and f is the number of dimensions of the feature of each frame.

Each of the unit of the frame individual feature quantity 138a, the unit of the frame individual feature quantity 138b, the unit of the frame individual feature quantity 138c, . . . is referred to as a frame.

The neural network 176 may calculate the individual feature quantity from the generated aggregated feature quantity using a neural network having a permutation-equivariant characteristic in which the same output can be obtained even if the order of inputs changes.

The neural network having the permutation-equivariant characteristic may be a neural network that performs neuro computation detection processing for each individual feature quantity.

### (7) MaxPooling Unit 177

The MaxPooling unit 177 (aggregation unit) reads the frame individual feature quantity data 138 from the storage circuit 108.

For the read frame individual feature quantity data 138, the MaxPooling unit 177 aggregates the frame individual feature quantities in the entire moving image 132 using GlobalMaxPooling, and generates an all-frame aggregated feature quantity 139. The all-frame aggregated feature quantity 139 includes a plurality of aggregated feature quantities.

Here, in GlobalMaxPooling, MaxPooling using a window size including all the frame individual feature quantities corresponding to the moving image 132 is performed in the entire moving image 132.

As described above, since the MaxPooling unit 177 aggregates the frame individual feature quantity data 138 in the entire moving image 132, the window size corresponds to the total number of frame individual feature quantities corresponding to the entire moving image 132.

The all-frame aggregated feature quantity 139 acquires the forward invariance for all frames.

The MaxPooling unit 177 writes the generated all-frame aggregated feature quantity 139 into the storage circuit 108.

The number of aggregated feature quantities generated by the MaxPooling unit 177 is less than the number of individual feature quantities generated by the neural network 176.

The MaxPooling unit 177 may use any of AveragePooling, SoftmaxPooling, and SelfAttention instead of MaxPooling.

### (8) DNN Unit 178

The DNN unit 178 (recognition unit) includes a deep neural network (DNN). The DNN is a neural network having four or more layers in order to handle deep learning.

The DNN unit 178 performs individual action recognition processing of recognizing an action for each recognition target (frame, object, or the like) in the moving image 132 by neuro computation processing using the aggregation result by the MaxPooling unit 177.

The DNN unit 178 reads the all-frame aggregated feature quantity 139 from the storage circuit 108.

For the read all-frame aggregated feature quantity 139, the DNN unit 178 recognizes an event appearing in a video by DNN, and estimates a label 140 indicating the recognized event.

As described above, in a case where a person or the like captured in the moving image is playing sports (baseball, basketball, soccer, and the like), for example, the DNN unit 178 estimates “sport” as a label.

The DNN unit 178 writes the label 140 obtained by estimation into the storage circuit 108.

### (9) Control Unit 179

The control unit 179 integrally controls the point detection unit 171, the neural network 172, the MaxPooling unit 173, the neural network 174, the MaxPooling unit 175, the neural network 176, the MaxPooling unit 177, and the DNN unit 178.

The control unit 179 reads a label written in the storage circuit 108, and outputs the read label to the main control unit 110.

### 1.5 Operation in Recognition Device 10

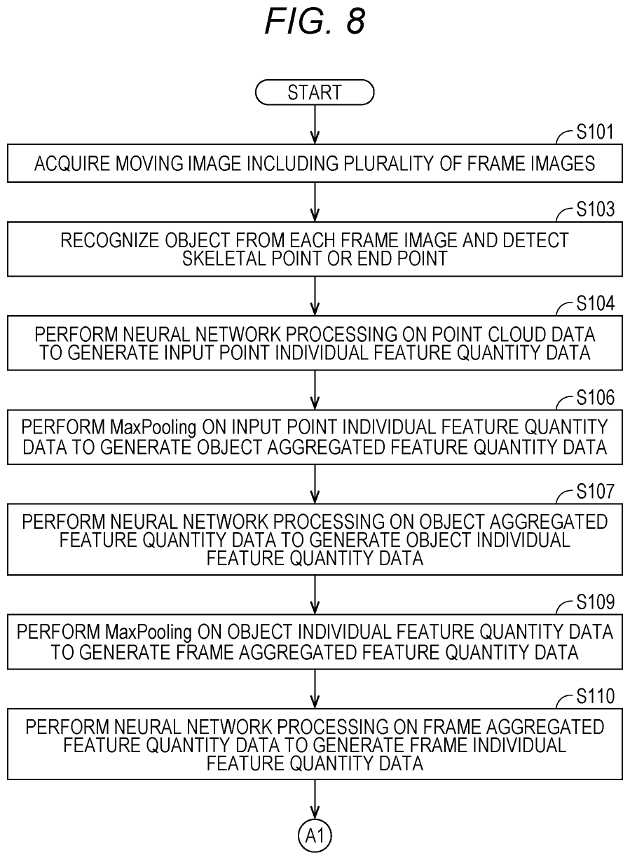

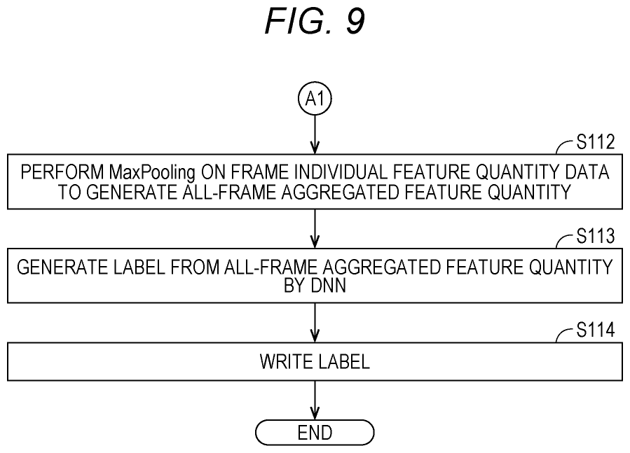

An operation in the recognition device 10 will be described with reference to flowcharts illustrated in FIGS. 8 to 9.

The input circuit 109 acquires the moving image 132 including a plurality of frame images from the camera 5 (step S101).

The point detection unit 171 recognizes an object from each frame image, detects a skeletal point or an end point, and generates the point cloud data 133 (step S103).

The neural network 172 performs neural network processing on the point cloud data 133 to generate the input point individual feature quantity data 134 (step S104).

The MaxPooling unit 173 performs GlobalMaxPooling on the input point individual feature quantity data 134 to generate the object aggregated feature quantity data 135. As a result, forward invariance can be obtained for each object. (Step S106).

The neural network 174 performs neural network processing on the object aggregated feature quantity data 135 to generate the object individual feature quantity data 136 (step S107).

The MaxPooling unit 175 performs GlobalMaxPooling on the object individual feature quantity data 136 to generate the frame aggregated feature quantity data 137. As a result, the forward invariance can be obtained for each frame. (Step S109).

The neural network 176 performs the neural network processing on the frame aggregated feature quantity data 137 to generate the frame individual feature quantity data 138 (step S110).

The MaxPooling unit 177 performs GlobalMaxPooling on the frame individual feature quantity data 138 to generate the all-frame aggregated feature quantity 139. As a result, the forward invariance can be obtained for all the frames. (Step S112).

The DNN unit 178 estimates the label 140 from the all-frame aggregated feature quantity 139 by DNN and generates the label (step S113).

The DNN unit 178 writes the label 140 obtained by estimation into the storage circuit 108 (step S114).

Thus, the recognition operation in the recognition device 10 is ended.

### 1.6 Summary

As described above, the moving image 132 (video) may include a plurality of unit images (for example, pixels) having the size of the first unit and a plurality of unit images (for example, objects) having the size of the second unit larger than the size of the first unit and smaller than the size of the entire video.

The recognition device 10 that performs recognition processing on a video obtained by capturing may include the neural network 172 (extraction unit) that extracts, from a video, an individual feature quantity (input point individual feature quantity) indicating a feature of the unit image (for example, pixel) having the size of the first unit, the MaxPooling unit 173 (aggregation unit) that aggregates, in a case where a plurality of individual feature quantities (input point individual feature quantities) are extracted by the neural network 172 (extraction unit), the plurality of extracted individual feature quantities for each unit image (for example, object) having the size of the second unit, and the DNN unit 178 (recognition unit) that recognizes an event appearing in the video on the basis of an aggregation result.

In addition, the moving image 132 (video) may include a plurality of unit images (for example, objects) having the size of the first unit and a plurality of unit images (for example, frame images) having the size of the second unit larger than the size of the first unit and smaller than the size of the entire video.

In this case, the neural network 174 (extraction unit) may extract the individual feature quantity (object individual feature quantity) indicating a feature of the unit image (for example, object) having the size of the first unit, and in a case where a plurality of individual feature quantities (object individual feature quantities) are extracted, the MaxPooling unit 175 (aggregation unit) may aggregate the plurality of extracted individual feature quantities (object individual feature quantities) for each unit image (for example, frame image) having the size of the second unit.

Furthermore, the moving image 132 (video) may include a plurality of unit images (for example, frame images) having the size of the first unit and a plurality of unit images (for example, a plurality of frame images) having the size of the second unit larger than the size of the first unit and smaller than the size of the entire video.

In this case, the neural network 176 (extraction unit) may extract the individual feature quantity (frame individual feature quantity) indicating a feature of the unit image (for example, frame image) having the size of the first unit, and in a case where a plurality of individual feature quantities (frame individual feature quantities) are extracted, the MaxPooling unit 177 (aggregation unit) may aggregate the plurality of extracted individual feature quantities (frame individual feature quantities) for each unit image (for example, a plurality of frame images) having the size of the second unit.

In addition, the moving image 132 (video) may include a plurality of unit images (for example, pixels) having the size of the first unit and a plurality of unit images (for example, objects) having the size of the second unit larger than the size of the first unit and smaller than the size of the entire video. The moving image 132 (video) may further include a plurality of unit images (for example, frame images) having the size of the third unit larger than the size of the second unit and smaller than the size of the entire video.

In this case, the neural network 172 (extraction unit) may extract, from the video, the individual feature quantity (input point individual feature quantity) indicating a feature of the unit image (for example, pixel) having the size of the first unit.

Furthermore, in a case where a plurality of individual feature quantities (input point individual feature quantities) are extracted by the neural network 172 (extraction unit), the MaxPooling unit 173 (aggregation unit) may aggregate the plurality of extracted individual feature quantities for each unit image (for example, object) having the size of the second unit and generate a first aggregated feature quantity (object aggregated feature quantity).

Moreover, the neural network 174 (extraction unit) may extract a second individual feature quantity (object individual feature quantity) indicating a feature of the unit image (for example, object) having the size of the second unit from the first aggregated feature quantity (object aggregated feature quantity).

Furthermore, in a case where a plurality of second individual feature quantities (object individual feature quantities) are extracted by the neural network 174 (extraction unit), the MaxPooling unit 175 (aggregation unit) may further aggregate the plurality of extracted second individual feature quantities (object individual feature quantities) for each unit image (for example, frame image) having the size of the third unit, and generate the second aggregated feature quantity (frame aggregated feature quantity).

Moreover, the DNN unit 178 (recognition unit) may recognize an event by using the generated second aggregated feature quantity (frame aggregated feature quantity).

As described above, according to the first example, since the input point individual feature quantities are aggregated for each object (person, object, or the like), the possibility that one object aggregated feature quantity is damaged by another object can be suppressed to be low. Furthermore, since the object individual feature quantities are aggregated for each frame, the possibility that one frame aggregated feature quantity is damaged by another frame can be suppressed to be low. As a result, it is possible to obtain an excellent effect that a decrease in the accuracy of recognition performed on the basis of the aggregated feature quantity can be suppressed.

### 2. Second Example

A second example is a modification of the first example.

Here, differences from the first example will be mainly described.

A recognition device 10 of the second example tracks an action of one person or the like by associating a plurality of objects representing the same person or the like among objects representing a plurality of persons or the like captured in a plurality of frame images obtained at different times.

Specifically, the recognition device 10 detects objects of a plurality of persons from a plurality of frame images by using a neural network, and recognizes and extracts the attribute or the feature quantity such as gender, clothes, and age of the person from each of the detected objects of the plurality of persons.

The recognition device 10 determines whether or not an attribute or a feature quantity extracted from a first object detected from a first frame image matches an attribute or a feature quantity extracted from a second object detected from a second frame image. In a case where they match, it is considered that the first object and the second object represent the same person, and thus, the recognition device 10 can track the action of the person.

The recognition device 10 aggregates the feature quantities of the object of the person whose action has been tracked.

The object to be tracked is not limited to a person. The object to be tracked may be a movable object, for example, an automobile, a bicycle, an aircraft, or the like.

### 2.1 Recognition Processing Unit 121a

In the second example, the GPU 105 operates in accordance with a control program stored in the ROM 106 using the RAM 107 as a work area, so that the GPU 105, the ROM 106, and the RAM 107 constitute the recognition processing unit 121a instead of the recognition processing unit 121 of the first example.

The recognition processing unit 121a has a configuration similar to that of the recognition processing unit 121, and here, differences from the recognition processing unit 121 will be mainly described.

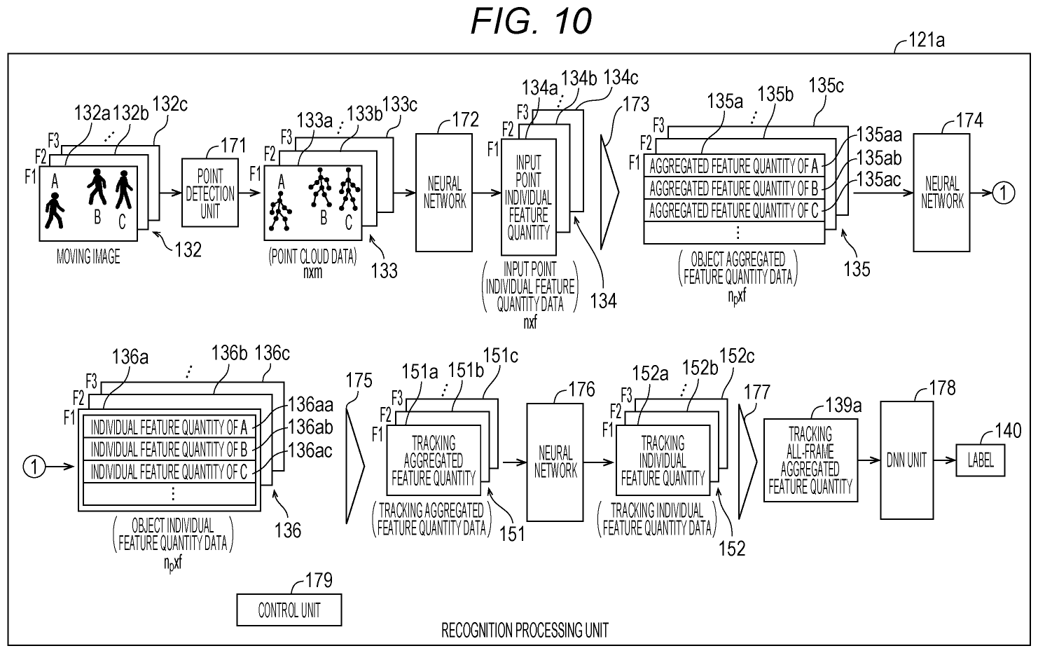

As illustrated in FIG. 10, the recognition processing unit 121a includes the point detection unit 171, the neural network 172, the MaxPooling unit 173, the neural network 174, the MaxPooling unit 175, the neural network 176, the MaxPooling unit 177, the DNN unit 178, and the control unit 179.

The neural network 172, the MaxPooling unit 173, and the neural network 174 in the recognition processing unit 121a have configurations similar to those of the neural network 172, the MaxPooling unit 173, and the neural network 174 of the recognition processing unit 121, respectively.

Here, the point detection unit 171, the MaxPooling unit 175, the neural network 176, the MaxPooling unit 177, and the DNN unit 178 in the recognition processing unit 121a will be described below, focusing on differences from the recognition processing unit 121.

### (1) Point Detection Unit 171

The point detection unit 171 performs the following processing in addition to the function of the point detection unit 171 in the recognition processing unit 121, that is, detection of a skeletal point or an end point.

The point detection unit 171 performs DeepSort (see Non Patent Literature 4) to track the object of the person by specifying the object of the same person appearing in a plurality of different frame images using the detected skeletal points or end points.

### (2) MaxPooling Unit 175

The MaxPooling unit 175 reads the object individual feature quantity data 136 from the storage circuit 108.

For the read object individual feature quantity data 136, the MaxPooling unit 175 aggregates the object individual feature quantities for each object of the person tracked by the point detection unit 171 using GlobalMaxPooling, and generates tracking aggregated feature quantity data 151.

As described above, for easy understanding, the tracking aggregated feature quantity data 151 is represented so as to include tracking aggregated feature quantities 151a, 151b, 151c, . . . corresponding to the frames.

The tracking aggregated feature quantities 151a, 151b, 151c . . . each include a plurality of aggregated feature quantities.

Each of the tracking aggregated feature quantities 151a, 151b, 151c, . . . acquires forward invariance for each object of the tracked person.

Each of the unit of the tracking aggregated feature quantity 151a, the unit of the tracking aggregated feature quantity 151b, the unit of the tracking aggregated feature quantity 151c, . . . is referred to as a frame.

The MaxPooling unit 175 writes the generated tracking aggregated feature quantity data 151 into the storage circuit 108.

### (3) Neural Network 176

The neural network 176 reads the tracking aggregated feature quantity data 151 from the storage circuit 108.

The neural network 176 performs neural network processing on the read tracking aggregated feature quantity data 151 to generate tracking individual feature quantity data 152.

As described above, for easy understanding, the tracking individual feature quantity data 152 is represented so as to include tracking individual feature quantities 152a, 152b, 152c, . . . corresponding to the frames.

The tracking individual feature quantities 152a, 152b, 152c . . . each include a plurality of individual feature quantities.

Here, as an example, as illustrated in FIG. 10, the tracking individual feature quantity 152a includes an individual feature quantity corresponding to the frame F1, the tracking individual feature quantity 152b includes an individual feature quantity corresponding to the frame F2, and the tracking individual feature quantity 152c includes an individual feature quantity corresponding to the frame F3.

The neural network 176 writes the generated tracking individual feature quantity data 152 into the storage circuit 108.

Each of the unit of the tracking individual feature quantity 152a, the unit of the tracking individual feature quantity 152b, the unit of the tracking individual feature quantity 152c, . . . is referred to as a frame.

### (4) MaxPooling Unit 177

The MaxPooling unit 177 reads the tracking individual feature quantity data 152 from the storage circuit 108.

For the read tracking individual feature quantity data 152, the MaxPooling unit 177 aggregates the individual feature quantities in the entire moving image using GlobalMaxPooling, and generates a tracking all-frame aggregated feature quantity 139a. The tracking all-frame aggregated feature quantity 139a includes a plurality of aggregated feature quantities.

The tracking all-frame aggregated feature quantity 139a acquires the forward invariance for all frames.

The MaxPooling unit 177 writes the generated tracking all-frame aggregated feature quantity 139a into the storage circuit 108.

### (5) DNN Unit 178

The DNN unit 178 reads the tracking all-frame aggregated feature quantity 139a from the storage circuit 108.

The DNN unit 178 estimates the label 140 from the read tracking all-frame aggregated feature quantity 139a by DNN.

### 2.2 Operation in Recognition Device 10 of Second Example

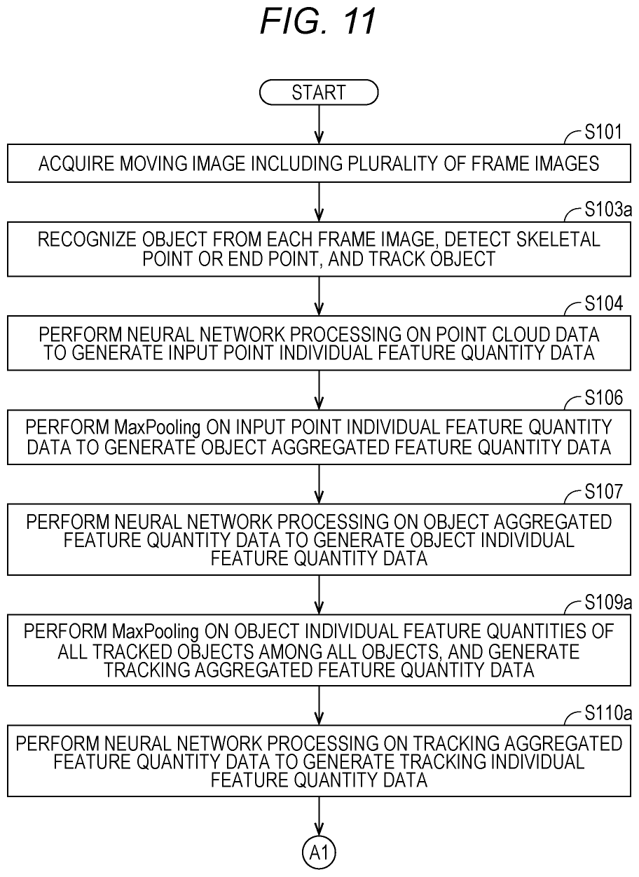

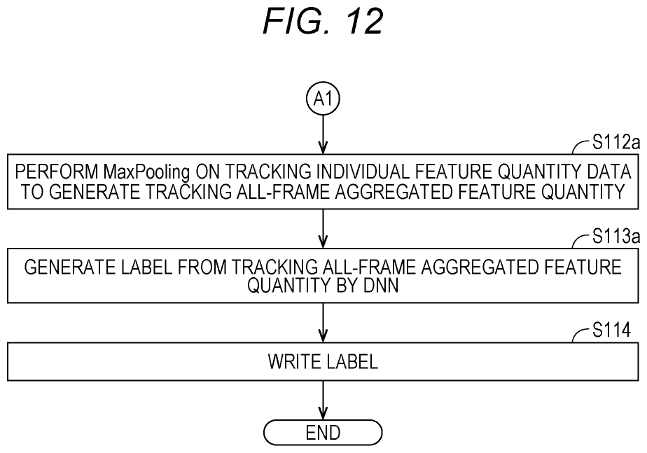

An operation in the recognition device 10 of the second example will be described with reference to flowcharts illustrated in FIGS. 11 to 12. Here, differences from the flowcharts illustrated in FIGS. 8 to 9 of the first example will be mainly described.

In a step subsequent to step S101, the point detection unit 171 recognizes an object from each frame image, detects a skeletal point or an end point, generates the point cloud data 133, and tracks the object (step S103a).

Furthermore, in a step subsequent to step S107, the MaxPooling unit 175 performs GlobalMaxPooling on the object individual feature quantities of all the tracked objects among all objects, and generates the tracking aggregated feature quantity data 151 (step S109a).

Next, the neural network 176 performs neural network processing on the tracking aggregated feature quantity data 151 to generate the tracking individual feature quantity data 152 (step S110a).

Next, the MaxPooling unit 177 performs GlobalMaxPooling on the tracking individual feature quantity data 152 to generate the tracking all-frame aggregated feature quantity 139a (step S112a).

Next, the DNN unit 178 generates a label from the tracking all-frame aggregated feature quantity 139a by DNN (step S113a).

Thus, the description of the recognition operation in the recognition device 10 of the second example is ended.

### 2.3 Summary

As described above, according to the second example, in a case where an object is tracked, the input point individual feature quantities are aggregated for each tracked object, for each object, and thus the possibility that the aggregated feature quantity of one tracked object is damaged by another tracked object can be suppressed to be low. As a result, it is possible to obtain an excellent effect that a decrease in the accuracy of recognition performed on the basis of the aggregated feature quantity can be suppressed.

### 3. Third Example

A third example is a modification of the first example.

Here, differences from the first example will be mainly described.

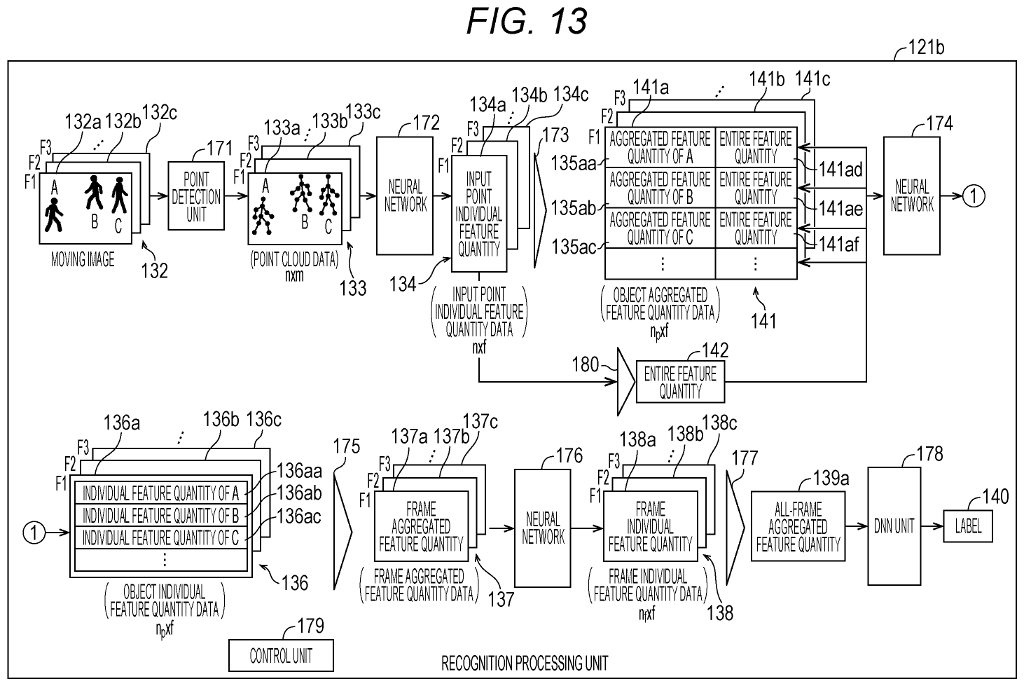

In the third example, the GPU 105 operates in accordance with a control program stored in the ROM 106 using the RAM 107 as a work area, so that the GPU 105, the ROM 106, and the RAM 107 constitute a recognition processing unit 121b as illustrated in FIG. 13 instead of the recognition processing unit 121 of the first example.

### 3.1 Recognition Processing Unit 121b

The recognition processing unit 121b is different from the recognition processing unit 121 in that a MaxPooling unit 180 is provided in addition to the configuration of the recognition processing unit 121 of the first example.

### (1) MaxPooling Unit 173

As described in the first example, the MaxPooling unit 173 generates the object aggregated feature quantities 135a, 135b, 135c, . . . (see FIG. 7).

Here, as an example, as illustrated in FIG. 7, the object aggregated feature quantity 135a includes the aggregated feature quantity 135aa corresponding to the object of the person A, the aggregated feature quantity 135ab corresponding to the object of the person B, the aggregated feature quantity 135ac corresponding to the object of the person C . . . . The same is applied to the object aggregated feature quantities 135b, 135c, . . . .

### (2) MaxPooling Unit 180

As illustrated in FIG. 13, the MaxPooling unit 180 performs GlobalMaxPooling on the entire input point individual feature quantity data 134 generated by the neural network 172 to generate an entire feature quantity 142.

The MaxPooling unit 180 duplicates the generated entire feature quantity 142 and combines the duplicated entire feature quantity with each of the aggregated feature quantity 135aa, the aggregated feature quantity 135ab, the aggregated feature quantity 135ac, . . . generated from the input point individual feature quantity 134a.

That is, the MaxPooling unit 180 duplicates the generated entire feature quantity 142 to generate an entire feature quantity 141ad, and combines the generated entire feature quantity 141ad with the aggregated feature quantity 135aa to generate a combined aggregated feature quantity. In addition, the MaxPooling unit 180 duplicates the generated entire feature quantity 142 to generate an entire feature quantity 141ae, and combines the generated entire feature quantity 141ae with the aggregated feature quantity 135ab to generate a combined aggregated feature quantity. Furthermore, the MaxPooling unit 180 duplicates the generated entire feature quantity 142 to generate an entire feature quantity 141af, and combines the generated entire feature quantity 141af with the aggregated feature quantity 135ac to generate a combined aggregated feature quantity.

Similarly, for the object aggregated feature quantities 135b, 135c, and . . . , the MaxPooling unit 180 duplicates the generated entire feature quantity 142 and combines the generated entire feature quantity 142 with the plurality of generated aggregated feature quantities.

As a result, the recognition processing unit 121b generates object aggregated feature quantities 141a, 141b, 141c, . . . instead of the object aggregated feature quantities 135a, 135b, 135c, . . . generated in the first example.

As illustrated in FIG. 13, the object aggregated feature quantity 141a includes a set (combined aggregated feature quantity) in which the aggregated feature quantity 135aa and the entire feature quantity 141ad are combined, a set (combined aggregated feature quantity) in which the aggregated feature quantity 135ab and the entire feature quantity 141ae are combined, a set (combined aggregated feature quantity) in which the aggregated feature quantity 135ac and the entire feature quantity 141af are combined, . . . .

The object aggregated feature quantities 141b, 141c, . . . are configured similarly to the object aggregated feature quantity 141a.

In this manner, the MaxPooling unit 180 generates object aggregated feature quantity data 141 including the object aggregated feature quantities 141a, 141b, 141c, . . . . The MaxPooling unit 180 writes the generated object aggregated feature quantity data 141 into the storage circuit 108.

### (3) Neural Network 174

As described in the first example, the neural network 174 generates object individual feature quantities 136a 136b, 136c, . . . including the individual feature quantity of each object by performing the neural network processing on each of the object aggregated feature quantities 141a, 141b, 141c, . . . generated as described above, instead of generating the object individual feature quantities 136a, 136b, 136c, . . . including the individual feature quantity of each object by performing the neural network processing on each of the object aggregated feature quantities 135a, 135b, 135c, . . . .

### 3.2 Operation in Recognition Device 10 of Third Example

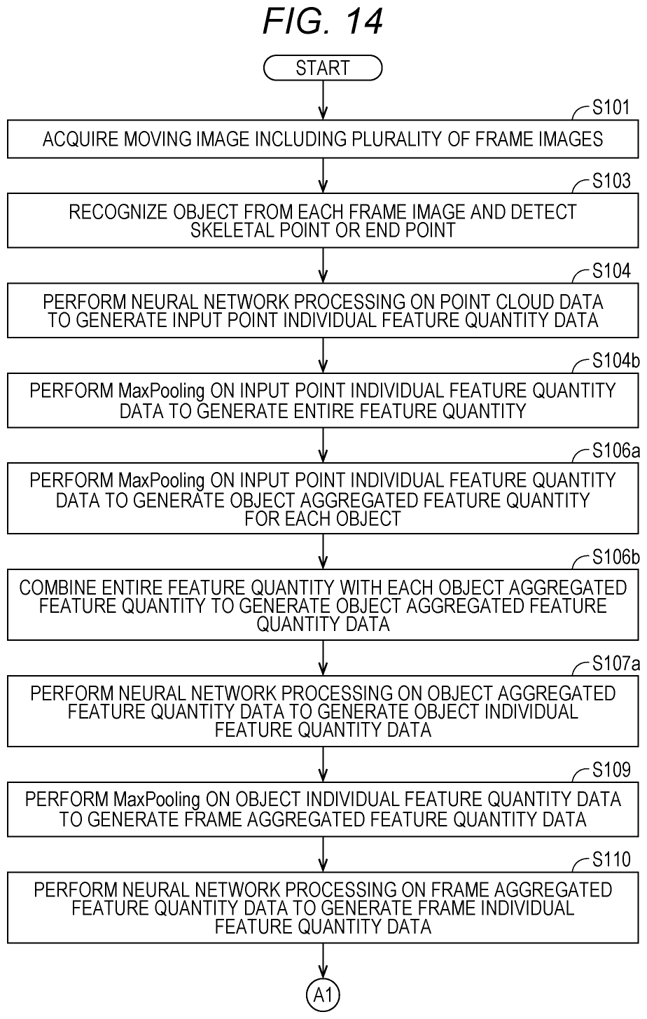

An operation in the recognition device 10 of the third example will be described with reference to a flowchart illustrated in FIG. 14. Here, differences from the flowchart illustrated in FIG. 8 of the first example will be mainly described.

In a step subsequent to step S104, the MaxPooling unit 180 performs GlobalMaxPooling on the input point individual feature quantity data 134 to generate the entire feature quantity 142 (step S104b).

Next, the MaxPooling unit 173 performs GlobalMaxPooling on the input point individual feature quantity data 134 to generate the object aggregated feature quantity for each object (step S106a).

Next, the MaxPooling unit 180 combines the entire feature quantity 142 with each object aggregated feature quantity to generate the object aggregated feature quantity data 141 (step S106b).

Next, the neural network 174 performs neural network processing on the object aggregated feature quantity data 141 to generate the object individual feature quantity data 136 (step S107a).

Next, steps after step S109 are performed.

### 3.3 Summary

As described above, the MaxPooling unit 173 (aggregation unit) may aggregate a plurality of extracted input point individual feature quantities (individual feature quantities) to generate the object aggregated feature quantity (first aggregated feature quantity). In a case where a plurality of input point individual feature quantities (individual feature quantities) are extracted, the MaxPooling unit 180 (aggregation unit) may further aggregate the plurality of input point individual feature quantities (individual feature quantities) in the entire moving image 132 (video) to generate the entire feature quantity (second aggregated feature quantity), and combine the generated entire feature quantity (second aggregated feature quantity) with the object aggregated feature quantity (first aggregated feature quantity) generated for each second unit (object) to generate the combined aggregated feature quantity. The DNN unit 178 (recognition unit) may recognize an event by using the generated combined aggregated feature quantity.

As described above, according to the third example, since the neural network processing is performed on the combined body generated by combining the entire feature quantity with the aggregated feature quantity of each object, it is possible to suppress the possibility that the aggregated feature quantity of one object is damaged by another object without losing the features obtained from the entire video. As a result, it is possible to obtain an excellent effect that a decrease in the accuracy of recognition performed on the basis of the aggregated feature quantity can be suppressed.

The configuration may be as follows.

The moving image 132 (video) may include a plurality of unit images (for example, pixels) having the size of the first unit, a plurality of unit images (for example, objects) having the size of the second unit larger than the size of the first unit and smaller than the size of the entire video, and a plurality of unit images (for example, frame images) having the size of the third unit larger than the size of the second unit.

The MaxPooling unit 173 (aggregation unit) may aggregate a plurality of extracted input point individual feature quantities (individual feature quantities) to generate the object aggregated feature quantity (first aggregated feature quantity).

In a case where a plurality of input point individual feature quantities (individual feature quantities) are extracted, the MaxPooling unit 180 (aggregation unit) may aggregate the plurality of input point individual feature quantities for each frame image including a unit image having the size of the third unit to generate the frame entire feature quantity (second aggregated feature quantity), and combine the generated second aggregated feature quantity with the first aggregated feature quantity generated for each second unit (object) to generate the combined aggregated feature quantity. The DNN unit 178 (recognition unit) may recognize an event by using the generated combined aggregated feature quantity.

In this way, since the neural network processing is performed on the combined body generated by combining the frame entire feature quantity with the aggregated feature quantity of each object, it is possible to suppress the possibility that the aggregated feature quantity of one object is damaged by another object without losing the features obtained from the entire frame image. As a result, it is possible to obtain an excellent effect that a decrease in the accuracy of recognition performed on the basis of the aggregated feature quantity can be suppressed.

### 4. Fourth Example

A fourth example is a modification of the first example.

Here, differences from the first example will be mainly described.

In the fourth example, a value (degree of contribution) indicating which recognition target (frame, object, or the like) has contributed to the inference of action classification is calculated.

An error between a label estimated by the configuration of the first example and a teacher label in a case where a predetermined action is determined to be correct is calculated. Subsequently, gradient information indicating the gradient of the error with respect to a value of each dimension of the individual feature quantity of each recognition target is calculated using the back propagation method. The degree of contribution of the individual feature quantity obtained for each recognition target is calculated using the calculated gradient information.

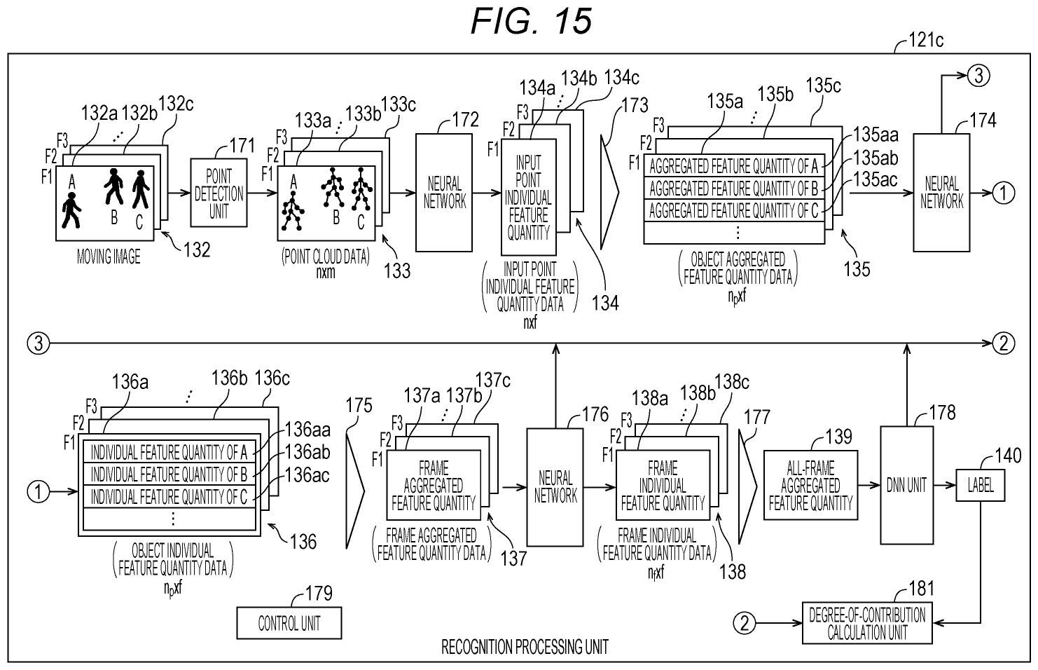

In the fourth example, the GPU 105 operates in accordance with a control program stored in the ROM 106 using the RAM 107 as a work area, so that the GPU 105, the ROM 106, and the RAM 107 constitute a recognition processing unit 121c as illustrated in FIG. 15 instead of the recognition processing unit 121 of the first example.

### 4.1 Recognition Processing Unit 121c

The recognition processing unit 121c includes a degree-of-contribution calculation unit 181 in addition to the configuration of the recognition processing unit 121 of the first example.

The degree-of-contribution calculation unit 181 calculates an error L between a label D estimated by the configuration of the first example and a teacher label T in a case where a predetermined action is determined to be correct.

$$L = \vert T - D \vert$$

Next, the degree-of-contribution calculation unit 181 calculates, using the back propagation method, a gradient ∂L/∂x₁, . . . , ∂L/∂x_{f} of the error L with respect to the value of each dimension of the individual feature quantity obtained for each frame, and a gradient ∂L/∂y₁, . . . , ∂L/∂y_{f} of the error L with respect to the value of each dimension of the individual feature quantity obtained for each object. Here, (x₁, . . . , x_{f}) is a value of each dimension of the individual feature quantity (for example, individual feature quantity 138a) of one frame among the individual feature quantities obtained for the individual frames. In addition, (y₁, . . . , y_{f}) is a value of each dimension of the individual feature quantity (for example, individual feature quantity 136aa) of one object among the individual feature quantities obtained for the individual objects.

Next, the degree-of-contribution calculation unit 181 calculates the degree of contribution of the individual feature quantity of one frame=(∂L/∂x₁)²+ . . . +(∂L/∂x_{f})², and the degree of contribution of the individual feature quantity of one object=(∂L/∂y₁)²+ . . . +(∂L/∂y_{f})².

The degree-of-contribution calculation unit 181 similarly calculates the degree of contribution of the individual feature quantity (138b, 138c, . . . ) of the other frame and the degree of contribution of the individual feature quantity (136ab, 136ac, . . . ) of the other object.

In this manner, the degree-of-contribution calculation unit 181 calculates the degree of contribution of the individual feature quantity obtained for each target.

The degree-of-contribution calculation unit 181 writes the calculated degree of contribution into the storage circuit 108.

The control unit 179 reads the degree of contribution written in the storage circuit 108, and outputs the read degree of contribution to the main control unit 110.

The main control unit 110 receives the degree of contribution from the recognition processing unit 121. When receiving the degree of contribution, the main control unit executes control to transmit the received degree of contribution to an external information terminal via the network communication circuit 111 and the network.

In this manner, the degree-of-contribution calculation unit 181 calculates the degree of contribution of the recognition target to the recognition result by backpropagating the gradient information related to neuro computation using the recognition result obtained by recognition.

### 4.2 Operation of Degree-of-Contribution Calculation Unit 181

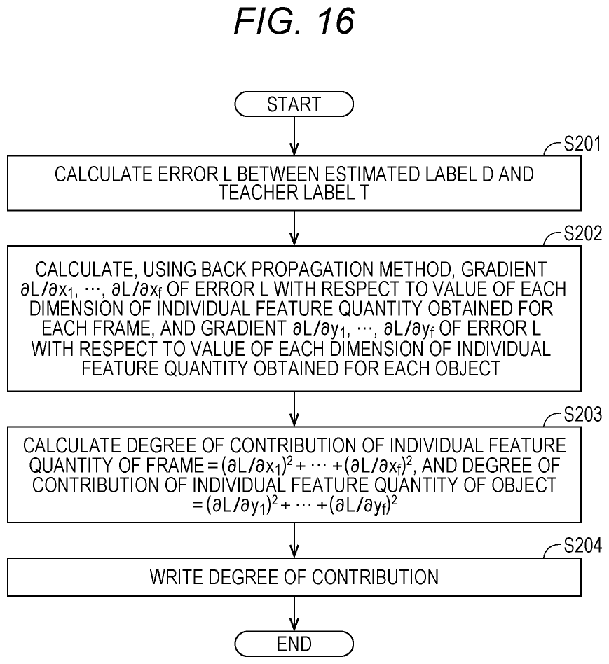

An operation of the degree-of-contribution calculation unit 181 will be described with reference to a flowchart illustrated in FIG. 16.

The degree-of-contribution calculation unit 181 calculates the error L between the estimated label D and the teacher label T in a case where a predetermined action is determined to be correct.

$$L = \vert T - D \vert ( step S 201 )$$

Next, the degree-of-contribution calculation unit 181 calculates, using the back propagation method, the gradient ∂L/∂x₁, . . . , ∂L/∂x_{f} of the error L with respect to the value of each dimension of the individual feature quantity obtained for each frame, and the gradient ∂L/∂y₁, . . . , ∂L/∂y_{f} of the error L with respect to the value of each dimension of the individual feature quantity obtained for each object (step S202).

Next, the degree-of-contribution calculation unit 181 calculates the degree of contribution of the individual feature quantity of one frame=(∂L/∂x₁)²+ . . . +(∂L/∂x_{f})², and the degree of contribution of the individual feature quantity of one object=(∂L/∂y₁)²+ . . . +(∂L/∂y_{f})². The degree-of-contribution calculation unit 181 similarly calculates the degree of contribution of the individual feature quantity (138b, 138c, . . . ) of the other frame and the degree of contribution of the individual feature quantity (136ab, 136ac, . . . ) of the other object (step S203).

The degree-of-contribution calculation unit 181 writes the calculated degree of contribution into the storage circuit 108 (step S204).

### 4.3 Summary

As the obtained degree of contribution is higher, it can be determined that the recognition target has contributed to the estimation of the label.

As a result, it is possible to find which recognition target has contributed to the inference of the action classification.

### 5. Other Modifications

(1) In each of the examples, the monitoring system 1 includes one camera 5 and the recognition device 10. However, it is not limited thereto.

The monitoring system may include a plurality of cameras and a recognition device. The recognition device receives moving images from the individual cameras. The recognition device may perform the recognition processing on the plurality of received moving images.
(2) The embodiments and the modifications may be combined.

### INDUSTRIAL APPLICABILITY

The recognition device according to the present disclosure has an excellent effect that the possibility that the aggregated feature quantity of the unit image having the size of the second unit is damaged by another unit image having the same size of the second unit can be suppressed to be low, and a decrease in the accuracy of recognition performed on the basis of the aggregated feature quantity can be suppressed, and is useful as a technique of recognizing an action of a person or the like from a moving image generated by capturing.

### REFERENCE SIGNS LIST

1 monitoring system
5 camera
10 recognition device
11 cable
50 neural network
50a input layer
50b feature extraction layer
50c recognition layer
101 CPU
102 ROM
103 RAM
104 storage circuit
105 GPU
106 ROM
107 RAM
108 storage circuit
109 input circuit
110 main control unit
111 network communication circuit
121 recognition processing unit
121a recognition processing unit
121b recognition processing unit
121c recognition processing unit
171 point detection unit
172 neural network
173 MaxPooling unit
174 neural network
175 MaxPooling unit
176 neural network
177 MaxPooling unit
178 DNN unit
179 control unit
180 MaxPooling unit

1. A recognition device that performs recognition processing on a video obtained by capturing, the recognition device comprising:
an extractor that extracts, from a video including a plurality of unit images having a size of a first unit and a plurality of unit images having a size of a second unit larger than the size of the first unit and smaller than a size of an entire video, an individual feature quantity indicating a feature of the unit image having the size of the first unit;
an aggregator that aggregates, in a case where a plurality of individual feature quantities are extracted by the extractor, the plurality of extracted individual feature quantities for each unit image having the size of the second unit; and
a recognitor that recognizes an event appearing in the video based on an aggregation result.

2. The recognition device according to claim 1, wherein
the aggregator aggregates a plurality of extracted individual feature quantities to generate an aggregated feature quantity, and
the recognitor recognizes an event by using the aggregated feature quantity generated.

3. The recognition device according to claim 1, wherein
the video further includes a plurality of unit images having a size of a third unit larger than a size of a second unit and smaller than a size of an entire video,
the aggregator aggregates a plurality of extracted individual feature quantities to generate a first aggregated feature quantity,
the extractor further extracts a second individual feature quantity indicating a feature of a unit image having the size of the second unit from the first aggregated feature quantity,
in a case where a plurality of second individual feature quantities are extracted by the extractor, the aggregator further aggregates the plurality of extracted second individual feature quantities for each unit image having the size of the third unit to generate a second aggregated feature quantity, and
the recognitor recognizes an event by using the second aggregated feature quantity generated.

4. The recognition device according to claim 3, wherein
the video is a moving image including a plurality of frame images, each frame image includes a plurality of point images arranged in a matrix, and each frame image includes a plurality of objects,
the first unit corresponds to a point image,
the second unit corresponds to an object, and
the third unit corresponds to a frame image.

5. The recognition device according to claim 3, wherein
the extractor calculates the second individual feature quantity from the first aggregated feature quantity generated using a neural network having a permutation-equivariant characteristic in which a same output can be obtained even if an order of inputs changes.

6. The recognition device according to claim 1, wherein
the video includes an object,
the recognition device further comprising a point detector that detects, from the video, point information indicating a skeletal point on a skeleton or a vertex on a contour of an object included in the video, and
the extractor extracts an individual feature quantity from the point information detected.

7. The recognition device according to claim 6, wherein
the video is a moving image including a plurality of frame images, each frame image includes a plurality of point images arranged in a matrix, and each frame image includes a plurality of objects, and
the unit image having a size of the second unit corresponds to a plurality of frame images, a frame image, or an object in the moving image.

8. The recognition device according to claim 7, wherein
the point information includes position coordinates indicating a position where a skeletal point or a vertex indicated by the point information is present in a frame image, and time axis coordinates indicating a frame image in which the skeletal point or the vertex indicated by the point information is present among a plurality of frame images.

9. The recognition device according to claim 8, wherein
the point information includes a feature vector indicating a unique identifier of the object,
the point information further includes at least one of a detection score indicating likelihood of a skeletal point or a vertex indicated by the point information detected, a feature vector indicating a type of an object including the skeletal point or the vertex indicated by the point information, a feature vector indicating a type of the point information, or a feature vector indicating an appearance of the object.

10. The recognition device according to claim 7, wherein
the point detector detects point information from one frame image or a plurality of frame images among the plurality of frame images.

11. The recognition device according to claim 10, wherein
the point detector detects the point information by neural network computation detection processing.

12. The recognition device according to claim 6, wherein
the extractor calculates the individual feature quantity from the point information using a neural network having a permutation-equivariant characteristic in which a same output can be obtained even if an order of inputs changes.

13. The recognition device according to claim 5, wherein
the neural network having a permutation-equivariant characteristic is a neural network that performs neuro computation detection processing for each individual feature quantity.

14. The recognition device according to claim 2, wherein
a number of aggregated feature quantities generated by the aggregator is smaller than a number of individual feature quantities generated by the extractor.

15. The recognition device according to claim 1, wherein
the video further includes a plurality of unit images having a size of a third unit larger than a size of a second unit,
the aggregator aggregates a plurality of extracted individual feature quantities to generate a first aggregated feature quantity,
in a case where a plurality of individual feature quantities are extracted by the extractor, the aggregator further aggregates a plurality of individual feature quantities for each unit image having the size of the third unit to generate a second individual feature quantity, and combines the second aggregated feature quantity generated with the first aggregated feature quantity generated for each second unit to generate a combined aggregated feature quantity, and
the recognitor recognizes an event by using the combined aggregated feature quantity generated.

16. The recognition device according to claim 1, wherein
the aggregator aggregates a plurality of extracted individual feature quantities to generate a first aggregated feature quantity,
in a case where a plurality of individual feature quantities are extracted by the extractor, the aggregator further aggregates a plurality of individual feature quantities in the entire video to generate a second individual feature quantity, and combines the second aggregated feature quantity generated with the first aggregated feature quantity generated for each second unit to generate a combined aggregated feature quantity, and
the recognitor recognizes an event by using the combined aggregated feature quantity generated.

17. The recognition device according to claim 1, wherein
the recognitor performs individual action recognition processing of recognizing an action for each recognition target in the video by neuro computation processing using an aggregation result by the aggregator.

18. The recognition device according to claim 17,
further comprising a degree-of-contribution calculator that calculates a degree of contribution of the recognition target to a recognition result by backpropagating gradient information related to a neuro computation using the recognition result obtained by recognition.

19. A recognition system comprising:
a capturing device that generates a video by capturing; and
the recognition device according to claim 1.

20. A non-transitory recording medium storing a computer readable computer program for control used in a recognition device that performs recognition processing on a video obtained by capturing, the program causing the recognition device, which is a computer, to perform:
extracting, from a video including a plurality of unit images having a size of a first unit and a plurality of unit images having a size of a second unit larger than the size of the first unit and smaller than a size of an entire video, an individual feature quantity indicating a feature of the unit image having the size of the first unit;
aggregating, in a case where a plurality of individual feature quantities are extracted by the extracting, the plurality of extracted individual feature quantities for each unit image having the size of the second unit; and
recognizing an event appearing in the video based on an aggregation result by the aggregating.
